(19) United States
(12) Patent Application Publication
(10) Pub. No.: US 2011/0059339 A1
(43) Pub. Date: Mar. 10, 2011

(54) METHOD FOR TREATING LITHIUM BATTERIES

(76) Inventors: Hiroshi Yamasaki, Shizuoka (JP); Michinari Shindoh, Shizuoka (JP); Kazutaka Arimura, Aichi (JP)

(21) Appl. No.: 12/933,443

(22) PCT Filed: Apr. 21, 2009
(86) PCT No.: PCT/JP2009/057883

§ 371 Date: Sep. 20, 2010

(30) Foreign Application Priority Data
May 28, 2008 (JP) 2008-140038

(51) Int. Cl. H01M 10/54

(52) U.S. Cl. 429/49

(57) ABSTRACT

Provided is a method for treating lithium batteries (100) having a positive electrode member (155) comprising an aluminum positive current collector (151) and a positive active material layer (152) containing a composite oxide of lithium and transition metal element positive active material (153) which is fixed to the positive current collector (151). The method includes an acid solution treatment process (step S4) wherein an acid solution, namely aqueous phosphoric acid solution, aqueous carbonic acid water or aqueous hydrogen sulfide, is brought into contact with the surface of the positive active material layer (152) and the positive current collector (151) which constitute the positive electrode member (155), and the positive active material layer (152) is separated from the positive current collector (151), and an oxalic acid treatment process (step S8) wherein the material for treatment (PM) containing metal components originating from the positive active material layer (152) is reacted with aqueous oxalic acid solution.

### TECHNICAL FIELD

The present invention relates to a method for treating lithium batteries and particularly to a technique of recovering valuable metals from a waste lithium battery.

### BACKGROUND ART

Many techniques have been proposed to recover or collect valuable metals from waste lithium batteries (for example, see Patent Literatures 1 to 3).

### CITATION LIST

### Patent Literature

Patent Literature 1: JP 10 (1998)-237419 A
Patent Literature 2: JP 2004-182533 A
Patent Literature 3: JP 2006-4883 A

Patent Literature 1 proposes the following technique. A battery is first crushed or pulverized together with a case thereof. The crushed objects are dissolved with mineral acid (sulfuric acid) and then filtered and separated. The resultant filtrate is brought into contact with organic solvent containing metal extractant of phosphorus compound.

Then, the mineral acid is brought into contact with extractant organic solvent phase for back extraction and separation to recover valuable metals.

Patent Literature 2 proposes the following technique. A lithium battery waste material (powder obtained by baking and crushing a lithium battery) is leached with inorganic acid, thereby obtaining a solution containing cobalt and also aluminum and iron as impurities. This solution is oxidized by addition of a hydrogen peroxide solution. Caustic soda is then added thereto to regulate PH to 4.0 to 5.5. Aging is performed at 30 to 90° C. for 120 to 480 minutes. By liquid-solution separation, successively, the impurities such as aluminum and iron are removed. Cobalt is thus recovered.
Patent Literature 3 proposes the following technique.

Firstly, an electrode assembly including a positive electrode member, a negative electrode member, and a separator, each having a sheet-shape is disassembled. The positive electrode member is then immersed in an oxalic acid solution to cause active materials and others to be self-exfoliated from a positive current collector (aluminum foil) by utilizing oxygen gas generated by reaction and also elute Li components contained in a positive active material into an oxalic acid solution. Thereafter, solid-liquid separation such as filtering is conducted to divide an insoluble transition metal compound and a soluble lithium component, thereby collecting transition metal.

### SUMMARY OF INVENTION

### Technical Problem

However, in the method of Patent Literature 1, large amounts of impurities are contained in the crushed objects. Accordingly, expensive metal extractant such as bisphosphinic acid derivative is required. This takes high recovery costs. Since large amounts of impurities are contained in the crushed objects, it is difficult to collect or recover valuable metals with high purity.

The technique of Patent Literature 2 have a problem that even if the impurities such as aluminum and iron can be removed by the liquid-solution separation but large amounts of impurities are contained in a cobalt solution. Specifically, elements (P, F, etc.) contained in the electrolyte are contained as impurities in the cobalt solution. Since the lithium battery waste materials contain large amounts of impurities, it is thus difficult to recover high-pure cobalt. Unless the impurities are removed, furthermore, cobalt could not be recovered appropriately. Such recovery treatment would be troublesome.

On the other hand, the technique of Patent Literature 3 separates the active materials and others from the positive current collector (aluminum foil) without causing mixture of a component constituting other parts such as a battery case and a component constituting the positive active material. Accordingly, the technique of Patent Literature 3 that can reduce the rate of the impurities to the positive active material (transition metal) is superior to Patent Literatures 1 and 2.

However, the technique of Patent Literature 3 has a problem that when the positive electrode member is immersed in the oxalic acid solution, part (about 10 wt % at a maximum) of aluminum constituting the positive current collector is eluted. A recovery rate of aluminum is thus low. Since aluminum originating from the positive current collector is also included in the impurities, it takes extra time and labor to remove them and the purity of transition metal recovered is decreased.

The present invention has been made in view of the circumstances and has a purpose to provide a method for treating lithium batteries to restrict elution of aluminum constituting a positive current collector and appropriately separate a positive active material layer from a the positive current collector.

### Solution to Problem

One aspect of the invention provides a method for treating lithium battery comprising a positive electrode member including: a positive current collector made of aluminum; and a positive active material layer containing a positive active material made of composite oxide including lithium and a transition metal element, the positive active material layer being fixed to the positive current collector, the method comprising: an acid solution treatment step of bringing one acid solution of phosphoric acid solution, carbonic acid water, and hydrogen sulfide water in contact with the positive active material layer and a surface of the positive current collector constituting the positive electrode member to separate the positive active material layer from the positive current collector; and an oxalic acid treatment step of bringing an oxalic acid aqueous solution in contact with a material for treatment containing a metal component originating from the positive active material layer.

In the above treatment method, one acid solution of phosphoric acid aqueous solution, carbonic acid water, and hydrogen sulfide water is brought in contact with the positive active material layer and the surface of the positive current collector constituting the positive electrode member to separate the positive active material layer from the positive current collector. The use of one acid solution of phosphoric acid aqueous solution, carbonic acid water, and hydrogen sulfide water can prevent elution of the aluminum constituting the positive current collector and appropriately separate the positive active material layer from the positive current collector.

Accordingly, it is possible to prevent the aluminum originating from the positive current collector from mixing as an impurity in the material for treatment including the metal component originating from the positive active material layer. Specifically, the content of aluminum (impurities) included in the material for treatment can be reduced.

It is to be noted that the material for treatment is a substance including impurities detached from the positive electrode member as well as the metal component (Li and transition metal component) originating from the positive active material layer. For example, these impurities may include P originating from LiPF6 in the electrolyte, Al originating from the positive current collector, Fe and Cr originating from constituent components of the battery.

The above treatment method further includes the oxalic acid treatment step of bringing oxalic acid aqueous solution in contact with the material for treatment. For instance, the material for treatment is immersed in the oxalic acid aqueous solution. At that time, the transition metal component (particularly, Ni, Co, Mn) originating from the positive active material reacts with oxalic acid, forming a poorly water-soluble oxalic acid compound, and hence it is hardly dissolved in the oxalic acid aqueous solution. On the other hand, other impurities (Al, Cr, Fe, P, etc.) react with oxalic acid, forming a water-soluble oxalic acid compound, and hence it is dissolved in the oxalic acid aqueous solution.

When phosphoric acid is used in the previous acid solution treatment step, the phosphoric acid reacts with the transition metal to generate phosphate. Phosphorous contained in this phosphate is eluted as H₃PO₄ in the solution in the oxalic acid treatment step. Thus, the transition metal (Ni, Co, Mn) and the phosphoric component can be separated.

Accordingly, the insoluble component (transition metal component originating from the positive active material) and the aqueous solution (impurities) are divided by the solid-liquid separation (filtering or others). This makes it possible to appropriately recover the transition metal component originating from the positive active material. In addition, as mentioned above, the content of aluminum (impurities) included in the material for treatment is reduced. The transition metal component with high purity (particularly, Ni, Co, Mn) can therefore be efficiently recovered.

From among the phosphoric acid aqueous solution, the carbonic acid water, and the hydrogen sulfide water, the acid solution treatment step preferably uses the phosphoric acid aqueous solution. Because this can most prevent elution of the aluminum constituting the positive current collector (the aluminum is hardly eluted).

In the case of using the phosphoric acid aqueous solution, it is conceivable that the positive active material layer is separated from the positive current collector as below. When the phosphoric acid aqueous solution is brought in contact with the positive active material layer, Li of the positive active material reacts with the phosphoric acid, generating oxygen gas. This oxygen gas can act to decrease the binding strength of the binder resin contained in the positive active material layer. Thus, in the positive active material layer, positive active material particles and others bonded to one another through the binder resin can be separated.

Even in an interface between the positive active material layer and the positive current collector, the oxygen gas generated by the reaction of phosphoric acid and Li can also act to decrease the binding strength of the binder resin. Furthermore, the phosphoric acid contacting with the surface of the positive current collector reacts with the aluminum constituting the positive current collector, thus forming an aluminum phosphate film or layer on the surface of the positive current collector. This aluminum phosphate film or layer can also decrease the binding strength between the positive current collector and the positive active material layer.

In addition, the aluminum phosphate film or layer formed on the surface of the positive current collector can prevent a possible reaction between the phosphoric acid aqueous solution and the aluminum constituting the positive current collector. The above acid solution treatment step can therefore prevent elution of the aluminum constituting the positive current collector. As above, while the elution of the aluminum constituting the positive current collector is prevented, the positive active material layer can be appropriately separated from the positive current collector.

In the above lithium battery treatment method, preferably, the transition metal element includes at least one of Ni, Co, and Mn.

The above treatment method is configured to treat the lithium battery including at least one of Ni, Co, and Mn. Ni, Co, and Mn are valuable metals having high rarity values. The above treatment method includes the acid solution treatment step and the oxalic acid treatment step as above. This method accordingly can prevent elution of the aluminum constituting the positive current collector and appropriately recover Ni, Co, and Mn.

In one of the above lithium battery treatment methods, preferably, the acid solution treatment step includes spraying the acid solution onto a surface of the positive active material layer.

The above treatment method includes the acid solution treatment step of spraying the acid solution (any one of the phosphoric acid aqueous solution, carbonic acid water, and hydrogen sulfide water) onto the surface of the positive active material layer. Thus, the acid solution permeates in the positive active material layer and then reaches the surface of the positive current collector. The acid solution is allowed to appropriately contact with the positive active material layer and the surface of the positive current collector.

One of the above lithium battery treatment methods, preferably, further comprises an underwater vibration step of immersing the positive electrode member in which the positive active material layer is separated from the positive current collector in vibrated water to remove the positive active material layer from the positive current collector and release the material for treatment including the metal component originating from the positive active material layer in the water, the underwater vibration step being to be performed after the acid solution treatment step and before the oxalic acid treatment step.

In the above treatment method, the positive electrode member in which the positive active material layer is separated from the positive current collector is immersed in the vibrated water. Thus, the positive active material layer is removed from the positive current collector and the metal component (Li and transition metal component) contained in the positive active material layer is released in the water and also impurities (Al, Cr, Fe, P, etc.) are detached from the positive electrode member and released in the water. That is, the material for treatment is released in the water.

Meanwhile, Li of the material for treatment constitutes a water soluble compound (e.g., lithium phosphate) by reaction with acid (e.g., phosphoric acid) in the previous acid solution treatment step. On the other hand, Al, Cr, Fe, etc. as well as the transition metal constitute poorly water-soluble compounds (e.g., nickel phosphate) by reaction with acid (e.g., phosphoric acid) in the acid solution treatment step. In particular, Ni, Co, and Mn constitute very poorly water-soluble compounds (e.g., nickel phosphate) by reaction with acid (e.g., phosphoric acid).

Accordingly, a Li component of the material for treatment is dissolved in the water but other components such as Al, Cr, Fe as well as the transition metal are hardly dissolved in the water. Thereafter, the material for treatment is separated into the insoluble component (phosphate of transition metal and other) and an aqueous solution (an aqueous solution containing lithium phosphate) by solid-liquid separation (filtering and others). The insoluble component (transition metal component and others) can be appropriately recovered. That is, the water soluble component (lithium phosphate and others) can be removed from the material for treatment.

It is preferable to conduct ultrasonic vibration using an ultrasonic oscillator for example to vibrate the water in which the positive electrode member is immersed.

The above lithium battery treatment method, preferably, further comprises a recovery step of separating the water containing the material for treatment released therein into an aqueous solution containing the dissolved lithium component and an insoluble component including the transition metal element and not being dissolved in the water to recover the insoluble component, the recovery step being to be performed after the underwater vibration step and before the oxalic acid treatment step, and the oxalic acid treatment step including bringing the oxalic acid aqueous solution in contact with the insoluble component.

In the above treatment method, the water containing the material for treatment is separated by solid-liquid separating (filtering or the like) into the insoluble component (residue including transition metal phosphate and others) and the aqueous solution (aqueous solution with dissolved lithium phosphate and others therein), and the insoluble component (the transition metal component and others) is recovered. Accordingly, the water-soluble component (lithium phosphate and others) can be removed from the material for treatment.

In the oxalic acid treatment step, thereafter, the material for treatment from which the water soluble component (lithium phosphate and others) has been removed, that is, the insoluble component (residue including transition metal phosphate and others) is made to react with the oxalic acid aqueous solution. Since the impurities other than the transition metal component (particularly, Ni, Co, Mn) to be recovered are reduced prior to the oxalic acid treatment step, the transition metal component (particularly, Ni, Co, Mn) with high purity can be recovered.

In one of the above lithium battery treatment methods, preferably, the oxalic acid aqueous solution has an oxalic acid concentration of 2.5 wt % or more and 25 wt % or less.

In the oxalic acid treatment step, in the case of using the oxalic acid aqueous solution of less than 2.5 wt %, the treatment time is longer and also the impurities such as phosphorous cannot be sufficiently dissolved. Accordingly, the impurities such as phosphorous and the transition metal component (particularly, Ni, Co, Mn) can not be separated appropriately.

On the other hand, in the above treatment method, the oxalic acid concentration of the oxalic acid aqueous solution is set to 2.5 wt % or more. This can relatively shorten the treatment time and sufficiently dissolve the impurities such as phosphorous.

As the oxalic acid concentration of the oxalic acid aqueous solution is higher, the impurities such as phosphorous can be dissolved more rapidly and sufficiently. However, when it exceeds 25 wt %, the reaction speed and the dissolving amount of the impurities such as phosphorous are almost unchanged. The use of the oxalic acid aqueous solution of more than 25 wt % results in waste of oxalic acid (decreases a cost effect). To obtain the oxalic acid aqueous solution of more than 25 wt %, the liquid temperature has to be increased to more than 55° C. (at which the oxalic acid aqueous solution of 25 wt % is saturated) and therefore more energy is required to heat the oxalic acid aqueous solution.

In the above treatment method, on the other hand, the oxalic acid concentration of the oxalic acid aqueous solution is set to 25 wt % or less. This makes it possible to avoid wasteful use of the oxalic acid and also save energy to heat the oxalic acid aqueous solution.

In the above lithium battery treatment method, preferably, the oxalic acid concentration of the oxalic acid aqueous solution is 7 wt % or more and 15 wt % or less.

By the use of the oxalic acid aqueous solution of 7 wt % or more, the impurities such as phosphorous can be dissolved rapidly and sufficiently. Consequently, the process time of the oxalic acid treatment can be shortened and also the transition metal (Ni, Co) with high purity can be recovered.

In addition, when the oxalic acid concentration of the oxalic acid aqueous solution is set to 15 wt % or less, the energy to heat the oxalic acid aqueous solution can be sufficiently saved. Because the oxalic acid aqueous solution of 15 wt % is saturated at 35° C. and hence the liquid temperature of the oxalic acid aqueous solution does not need to be increased to 35° C. or more.

In the above lithium battery treatment method, preferably, a temperature of the oxalic acid aqueous solution is 15° C. or more and 35° C. or less.

The liquid temperature at which oxalic acid aqueous solution of 7 wt % is saturated is 15° C. Thus, in the case of using the oxalic acid aqueous solution of 7 wt % or more, it is preferably to keep the liquid temperature of the oxalic acid aqueous solution at 15° C. or more. Furthermore, the liquid temperature at which the oxalic acid aqueous solution of 15 wt % is saturated is 35° C. In the case of using the oxalic acid aqueous solution of 15 wt % or less, accordingly, the liquid temperature of the oxalic acid aqueous solution does not need to be increased to 35° C. or more.

In the oxalic acid treatment step, consequently, in the case of using the oxalic acid aqueous solution of 7 wt % or more and 15 wt % or less, if the temperature of the oxalic acid aqueous solution is 15° C. or more and 35° C. or less (close to room temperature), it is possible to dissolve the impurities such as phosphorous rapidly and sufficiently. Since the liquid temperature is close to room temperature, the oxalic acid aqueous solution hardly needs to be heated. It is economical.

In one of the above lithium battery treatment methods, preferably, the acid solution has an acid concentration of 10 wt % or more and 40 wt % or less.

In the acid solution of less than 10 wt %, acid (phosphoric acid and others) and Al and others are slow to react with each other and also the positive active material layer cannot be appropriately separated from the positive current collector. In the above treatment method, on the other hand, the acid concentration of the acid solution is set to 10 wt % or more. Thus, the positive active material layer can be rapidly and reliably separated from the positive current collector.

As the acid concentration (phosphoric acid concentration, carbonic acid concentration, or hydrogen sulfide concentration) of the acid solution (phosphoric acid aqueous solution, carbonic acid water, or hydrogen sulfide water) is increased, the positive active material layer can be more rapidly and reliably separated from the positive current collector. If it exceeds 40 wt %, an excessive amount of acid more than required for separation is likely to be supplied. In the above treatment method, accordingly, the acid concentration of the acid solution is set to 40 wt % or less. It is therefore possible to avoid wasteful use of acid (phosphoric acid and others), which is economical.

In the above lithium battery treatment method, preferably, the acid concentration of the acid solution is 15 wt % or more and 25 wt % or less.

Since the acid concentration (phosphoric acid concentration, carbonic acid concentration, or hydrogen sulfide concentration) of the acid solution (phosphoric acid aqueous solution, carbonic acid water, or hydrogen sulfide water) is set to 15 wt % or more and 25 wt % or less, the positive active material layer can be separated rapidly and reliably from the positive current collector. Furthermore, the usage amount of acid (phosphoric acid and others) can be reduced and hence it is economical.

### BRIEF DESCRIPTION OF DRAWINGS

FIG. 1 is a plan view of a lithium battery;

FIG. 2 is a sectional view of the lithium battery viewed in a direction of arrow C in FIG. 1;

FIG. 3 is a sectional view of the lithium battery viewed in a direction of arrow D in FIG. 1;

FIG. 4 is an enlarged sectional view of an electrode assembly corresponding to a part B in FIG. 3;

FIG. 5 is a flowchart showing a flow of a battery treatment method in an embodiment;

FIG. 6 is a view showing an acid solution treatment device in the embodiment; and

FIG. 7 is a graph showing a relation between oxalic acid treatment time and a rate of content of phosphorous.

### DESCRIPTION OF EMBODIMENTS

A detailed description of a preferred embodiment of the present invention will now be given referring to the accompanying drawings.

A lithium battery 100 to be treated will be explained prior to explaining a treatment method of the present embodiment.

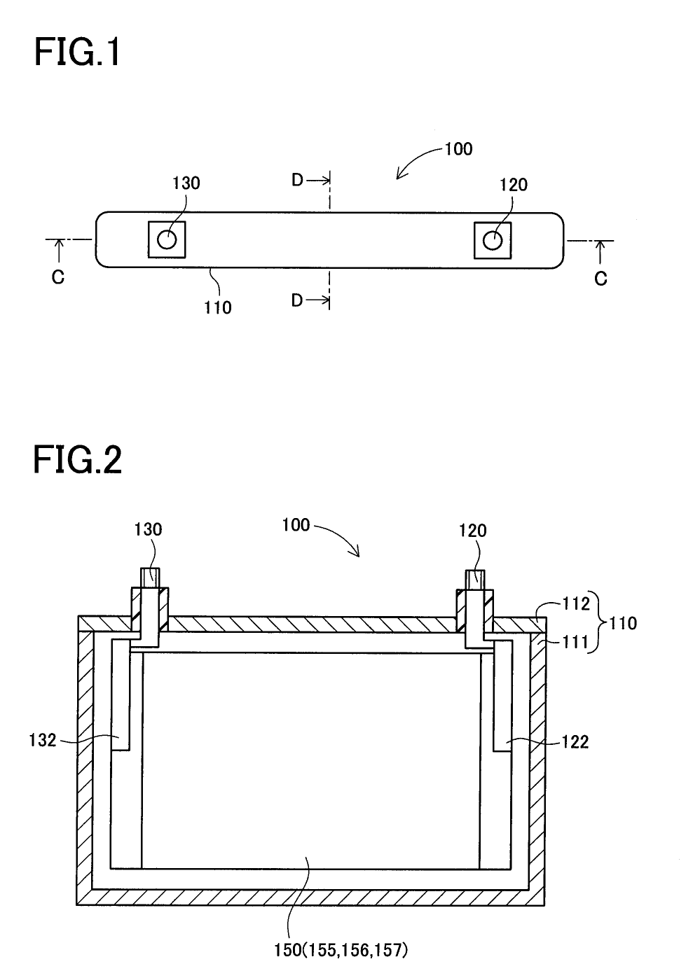

The lithium battery 100 is a sealed lithium ion secondary battery including a rectangular parallelepiped battery case 110, a positive terminal 120, and a negative terminal 130 as shown in FIGS. 1 and 2. The battery case 110 is made of metal and includes a rectangular housing part 111 forming a rectangular parallelepiped housing space and a metal lid part 112. The battery case 110 (the rectangular housing part 111) contains an electrode assembly 150 and a nonaqueous electrolyte (not shown).

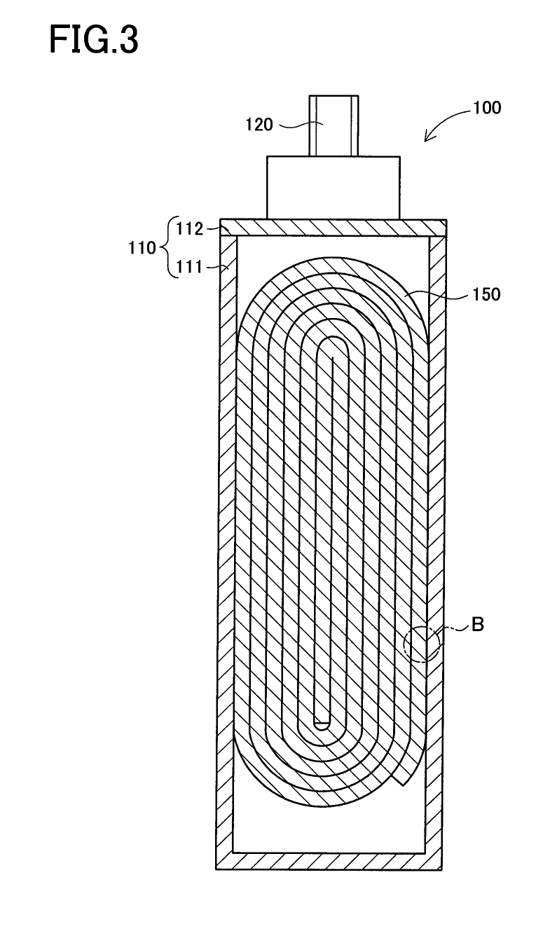

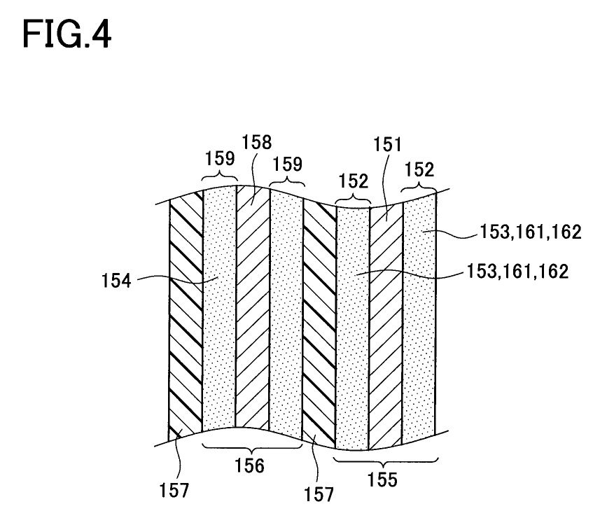

The electrode assembly 150 is a flat wound electrode assembly having an elliptic cross section as shown in FIG. 3 and including a positive electrode member 155, a negative electrode member 156, and a separator 157, each having a sheet shape, which are laminated one on another as shown in FIG. 4. The positive electrode member 155 includes a positive current collector 151 (aluminum foil) and positive active material layers 152 formed on surfaces of this positive current collector 151. The negative electrode member 156 includes a negative current collector 158 (copper foil) and negative active material layers 159 (including negative active material 154) formed on surfaces of this negative current collector 158.

Each positive active material layer 152 includes positive active material 153, conductive carbon 161, and binder resin 162 binding them. In this embodiment, the positive active material 153 used herein is composite oxide expressed by LiNi₍₁₋ₓ₎ COₓO₂. In this embodiment, X=0.15. That is, LiNi_{0.85}CO_{0.15}O₂ is used. The binder resin 162 used herein is PTFE (polytetrafluoroethylene), CMC (carboxymethyl cellulose), and PEO (polyethylene oxide).

As the nonaqueous electrolyte, there is used an electrolyte prepared by dissolving lithium hexafluorophosphate (LiPF₆) into a mixed solvent containing propylene carbonate, ethylene carbonate, dimethyl carbonate, and tetrahydrofuran.

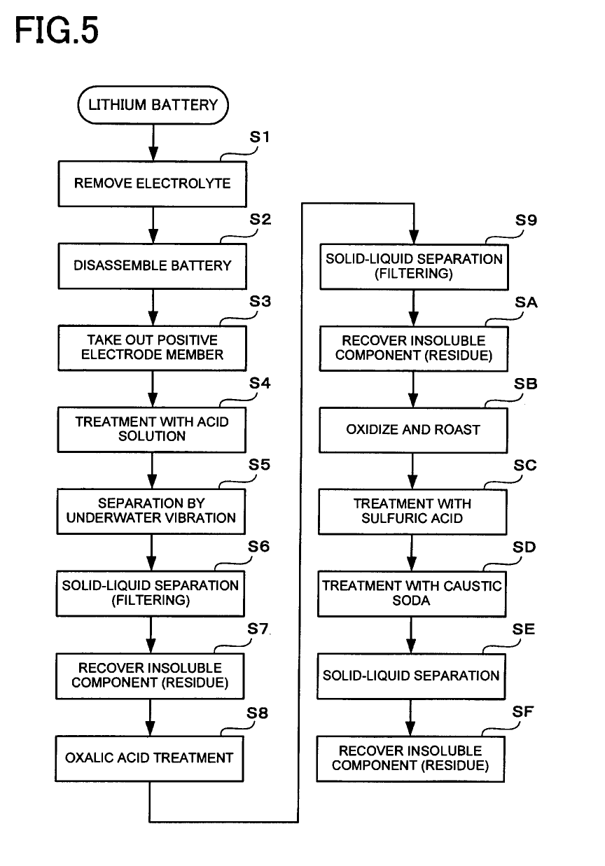

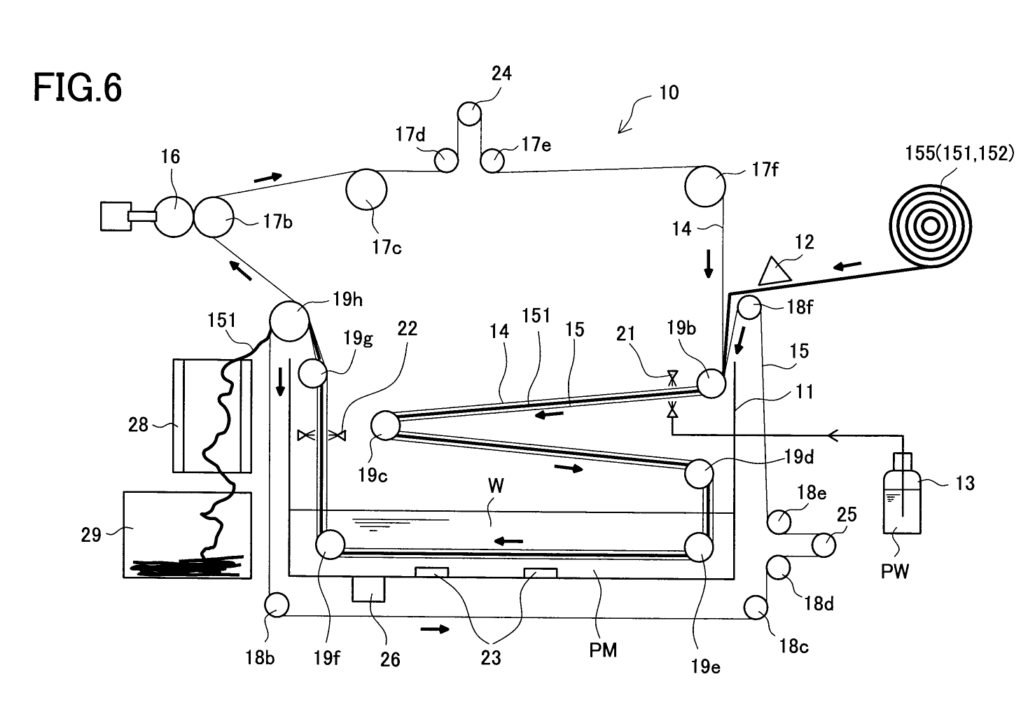

The treatment method of the lithium battery 100 in the present embodiment will be explained below referring to FIGS. 5 and 6.

Firstly, a used lithium battery 100 (a lithium battery to be discarded) is prepared. In step S1, a nonaqueous electrolyte (organic solvent) is removed from the lithium battery 100 by a known technique (see JP 2006-4883A, for example). To be concrete, a through hole is formed in the lid part 112 of the battery case 110, and the lithium battery 100 is put in a treatment chamber of a known vacuum heat treatment device not shown (see JP 2006-4883A, for example). The treatment chamber is depressurized and heated, thereby volatilizing and removing the organic solvent of the nonaqueous electrolyte.

In step S2, the lithium battery 100 is disassembled. To be concrete, the battery case 110 is cut to divide into the rectangular housing part 111 and the lid part 112. Then, the electrode assembly 150 and others are taken out from the battery case 110 (the rectangular housing part 111). A positive lead 122 and a negative lead 132 (see FIG. 2) attached to the electrode assembly 150 are detached from the electrode assembly 150. In step S3, the electrode assembly 150 is mechanically separated into the positive electrode member 155, the negative electrode member 156, and the separator 157, and the sheet-shaped positive electrode member 155 is taken out. This positive electrode member 155 is rewound in a roll form and then set in an acid solution treatment device 10 described later.

On the positive electrode member 155 (the positive current collector 151 and the positive active material layer 152), LiPF₆ contained in the nonaqueous electrolyte and some components such as Fe and Cr originating from parts or constituent components of a battery have stuck as impurities.

Herein, the acid solution treatment device 10 in this embodiment is explained. This device 10 includes, as shown in FIG. 6, a rectangular box-shaped treatment bath 11, a supply part 12 for feeding the positive electrode member 155 wound in a roll form, an acid solution tank 13 containing a phosphoric acid aqueous solution PW, carrier nets 14 and 15, a drive motor 16 for moving the carrier net 14, guide rollers 17b to 17f, 18b to 18f, and 19b to 19h, tension adjusters 24 and 25, a drier 28, and a recovery box 29.

Each of the carrier nets 14 and 15 is a net made of polypropylene resin and has a long annular shape. The carrier net 14 is wound over the guide rollers 17b to 17f and 19b to 19h and the tension adjuster 24 and held under tension by the tension adjuster 24 to annularly extend over the inside and the outside (upper in FIG. 6) of the treatment bath 11. The carrier net 15 is wound over the guide rollers 18b to 18f and 19b to 19h and the tension adjuster 25 and held under tension by the tension adjuster 25 to annularly extend over the inside and the outside (lower in FIG. 6) of the treatment bath 11.

The carrier net 14 is moved clockwise in FIG. 6 by being guided by the guide rollers 17b to 17f and 19b to 19h by driving of the drive motor 16. The carrier net 15 is brought in close contact with the carrier net 15 in the positions of the guide rollers 19b and 19h. Accordingly, along with movement of the carrier net 14, the carrier net 15 is moved counterclockwise in FIG. 6 by being guided by the guide rollers 18b to 18f and 19b to 19h. The positive electrode member 155 fed out from the supply part 12 is sandwiched between the carrier nets 14 and 15 in the portion of the guide roller 19b and then guided along the guide rollers 19b to 19f in this order to move the inside of the treatment bath 11.

In the treatment bath 11, a pair of spray nozzles 21 for spraying the phosphoric acid aqueous solution PW contained in the acid solution tank 13 and a pair of spray nozzles 22 for spraying wash water. The pair of spray nozzles 21 are located between the guide rollers 19b and 19c and arranged in positions to interpose the carrier nets 14 and 15 between the nozzles 21 (in positions above the carrier net 14 and below the carrier net 15 in FIG. 6). Thus, those nozzles 21 can spray the phosphoric acid solution PW onto the surfaces of the positive active material layers 152 fixed to both surfaces of the positive current collector 151. The phosphoric acid aqueous solution PW will penetrate into the inside of each positive active material layer 152 and then reach each surface of the positive current collector 151. Thus, the phosphoric acid aqueous solution PW appropriately comes into contact with the positive active material layers 152 and the surface of the positive current collector 151.

In this embodiment, the phosphate concentration of the phosphoric acid aqueous solution PW is determined to be 10 wt % or more and 40 wt % or less and specifically 15 wt % or more and 25 wt % or less (concretely, 20 wt %). The temperature of the phosphoric acid aqueous solution PW is set at 25° C. (room temperature). The quantity of the phosphoric acid aqueous solution PW to be sprayed from each spray nozzle 21 is regulated to 3.0 to 4.0 g per 100 cm².

The treatment bath 11 contains water W. Furthermore, an ultrasonic oscillator 23 is placed on the bottom of the treatment bath 11. Accordingly, the water W in the treatment bath 11 is ultrasonically vibrated by the ultrasonic oscillator 23. The guide rollers 19e and 19f are placed in the water W. After treatment with the phosphoric acid aqueous solution PW, therefore, the positive electrode member 155 remaining sandwiched between the carrier nets 14 and 15 is immersed in the ultrasonic-vibrated water W during movement from the position of the guide roller 19e to the position of the guide roller 19f.

The positive active material layers 152 are removed from the positive current collector 151, metal components (Li and transition metal components) contained in the positive active material layers 152 are released in the water W and the impurities (Al, Cr, Fe, P, etc.) stuck to the positive electrode member 155 are also released in the water W. That is, materials for treatment PM are released in the water W.

In this embodiment, the rotation speed of the drive motor 16 is controlled to take 30 to 45 seconds from when the phosphoric acid aqueous solution PW is sprayed onto the surfaces of the positive active material layers 152 up to when the positive electrode member 155 is immersed in the water W. The time for which the positive electrode member 155 is immersed in the water W is 20 to 30 seconds.

In this embodiment, the ultrasonic oscillator 23 applies vibration energy of 1 kW to the water W.

In step S4, subsequently, by use of the acid solution treatment device 10 (see FIG. 6), the positive active material layers 152 and the surface of the positive current collector 151 constituting the positive electrode member 155 are exposed to the phosphoric acid aqueous solution (acid solution), separating the positive active material layers 152 from the positive current collector 151. Specifically, the acid solution treatment device 10 is activated to feed the positive electrode member 155 wound in a roll form from the supply part 12. The positive electrode member 155 sandwiched between the carrier nets 14 and 15 is moved into the treatment bath 11 and passes between the pair of spray nozzles 21.

At that time, the spray nozzles 21 spray the phosphoric acid aqueous solution PW onto the surfaces of the positive active material layers 152 fixed on both surfaces of the positive current collector 151. Thus, the phosphoric acid aqueous solution PW penetrates into each positive active material layer 152 and then reaches each surface of the positive current collector 151. Accordingly, the phosphoric acid aqueous solution PW is allowed to appropriately contact with the positive active material layers 152 and the surface of the positive current collector 151. It is conceivable that reactions expressed by the following reaction formulas (1) and (2) occur at that time.

6LiNiO₂+6H₃PO₄

→2Ni₃(PO₃)₂+2Li₃PO₄+9H₂O+7/2O₂ (1)

Al+H₃PO₃→ALPO₄+3/2H₂ (2)

The phosphoric acid penetrating into each positive active material layer 152 reacts with Li of the positive active material 153 and generates oxygen gas as expressed in the reaction formula (1). It can be considered that this oxygen gas acts to decrease binding strength of the binder resin 162 contained in each positive active material layer 152. In each positive active material layer 152, therefore, the positive active material 153 and the conductive carbon 161 bound by the binder resin 162 are separated from each other.

It is also conceivable that, at the interface between each positive active material layer 152 and the positive current collector 151, the oxygen gas acts to decrease the binding strength of the binder resin 162. The phosphoric acid contacting with each surface of the positive current collector 151 reacts with the aluminum constituting the positive current collector 151 as shown in the reaction formula (2), thus forming an aluminum phosphate film or layer made of an ultrathin foil having a thickness of 115 nm on each surface of the positive current collector 151. This aluminum phosphate film is also considered to decrease the binding strength between the positive current collector 151 and each positive active material layer 152.

Furthermore, when the aluminum phosphate film is formed on each surface of the positive current collector 151, it can reduce subsequent reaction between the phosphoric acid aqueous solution and the aluminum constituting the positive current collector 151. In the treatment in step S4 in this embodiment, accordingly, it is possible to prevent elution of the aluminum constituting the positive current collector 151. In the above way, the elution of the aluminum constituting the positive current collector 151 can be restrained and also the positive active material layers 152 can be separated appropriately from the positive current collector 151.

In this embodiment, step S4 corresponds to an acid solution treatment step.

In step S5, the positive electrode member 155 in which the positive active material layers 152 come unstuck from the positive current collector 151 is immersed in the vibrated water W. Thus, the positive active material layers 152 are removed from the positive current collector 151 and the materials for treatment PM including metal components originating from the positive active material layers 152 are released in the water W (see FIG. 6).

In this embodiment, the materials for treatment PM include metal components (Li and transition metal components) and the conductive carbon 161 and others contained in the positive active material layers 152, and impurities (Al, Cr, Fe, P, etc.) detached from the positive electrode member 155.

To be concrete, as shown in FIG. 6, the phosphoric acid aqueous solution PW is sprayed on the surfaces of the positive active material layers 152 and then the positive electrode member 155 remaining sandwiched between the carrier nets 14 and 15 is guided by the guide rollers 19c, 19d, and 19e to move into the ultrasonically vibrated water W. In this way, the positive electrode member 155 in which the positive active material layers 152 separated from the positive current collector 151 is immersed in the ultrasonically vibrated water W.

Since the positive electrode member 155 subjected to the acid solution treatment is immersed in the ultrasonically vibrated water W, the positive active material layers 152 are removed from the positive current collector 151 and metal components (Li and transition metal components) contained in the positive active material layers 152 are released in the water and also the impurities (Al, Cr, Fe, P, etc.) stuck to the positive electrode member 155 are released in the water. In other words, the materials for treatment PM are released in the water W.

In this embodiment, step S5 corresponds to an underwater vibration step.

Subsequently, the positive current collector 151 from which the positive active material layers 152 have been removed is moved upward in the water W while the positive current collector 151 remains sandwiched between the carrier nets 14 and 15, and then passes between the pair of spray nozzles 22 placed between the guide rollers 19f and 19g as shown in FIG. 6. At that time, the wash water is sprayed from the spray nozzles 22 toward the surfaces of the positive current collector 151. The residual components on the surfaces of the positive current collector 151 are washed out and those surfaces are cleaned. Then, the positive current collector 151 (aluminum foil) is guided to the outside of the treatment bath 11 and dried in the drier 28 and thus recovered in the recovery box 29.

Herein, the recovered positive current collector 151 (aluminum foil) is studied about penetration depth of P (phosphorous) by use of an X-ray photoelectron spectroscopy device (Model 5600 manufactured by Physical Electronics). As a result, the penetration of P from the surface to a depth of 1.5 nm is observed and no further penetration of P to a deeper location is observed. This aluminum foil contains a very small amount of P and can be treated as an Al metal waste material and reusable.

In weight measurement, one sheet of this aluminum foil (2 m long×10 cm wide) weighs 8.10 g. On the other hand, one sheet of a new positive current collector 151 (aluminum foil) (before use in the lithium battery 100) also weighs 8.10 g. Specifically, even though the phosphoric acid aqueous solution PW is brought in contact with the surfaces of the positive current collector 151 (aluminum foil) and thereby the positive active material layers 152 are separated from the positive current collector 151, the positive current collector 151 (aluminum foil) is not eluted. This result reveals that the use of a phosphoric acid aqueous solution can restrain (prevent) elution of aluminum constituting the positive current collector 151 and appropriately separate the positive active material layers 152 from the positive current collector 151.

Herein, as comparative examples 1 to 5, positive active material layers 152 are separated from positive current collectors 151 by use of the technique proposed in JP 2006-4883A. Firstly, an oxalic acid solution with the concentration (0.5 to 10 wt %) proposed in JP 2006-4883A is prepared. To be more specific, oxalic acid aqueous solutions of five kinds regulated to 2 wt %, 4 wt %, 6 wt %, 8 wt %, and 10 wt % are prepared. Then, the positive electrode members 155 are immersed in respective oxalic acid aqueous solutions to separate the positive active material layers 152 from the positive current collectors 151. The temperatures of the five oxalic acid aqueous solutions are equally set at 40° C.

The weight of each positive current collector 151 (aluminum foil) is measured. The results thereof are shown together with the results of the present embodiment in Table 1.

TABLE 1

| | | Concen- | Weight (g) | Weight (g) | |
|---|---|---|---|---|---|
| | Treatment | tration | before | after | Weight (g) |
| | solution | (wt %) | treatment | treatment | of dissolved |
| Present | Phosphoric | 20 | 8.10 | 8.10 | 0.00 |
| embodiment | acid | | | | |
| Comparative | Oxalic acid | 2 | | 8.06 | 0.04 |
| example 1 | | | | | |
| Comparative | | 4 | | 7.90 | 0.20 |
| example 2 | | | | | |
| Comparative | | 6 | | 7.71 | 0.39 |
| example 3 | | | | | |
| Comparative | | 8 | | 7.48 | 0.62 |
| example 4 | | | | | |
| Comparative | | 10 | | 7.31 | 0.79 |
| example 5 | | | | | |

As shown in Table 1, in each of comparative examples 1 to 5, the weight of each positive current collector 151 (aluminum foil) after the oxalic acid treatment decreases from the weight of each positive current collector 151 (aluminum foil) before the oxalic acid treatment. This shows that part of each positive current collector 151 (aluminum foil) is eluted due to contact with the oxalic acid.

As shown in Table 1, as the oxalic acid concentration of the oxalic acid aqueous solution is lower, the more the elution of aluminum could be restrained but it takes long to separate the positive active material layers 152 from the positive current collectors 151. To be concrete, in the case of using the oxalic acid of 2 wt %, the treatment time (a duration of time to immerse the positive electrode member 155 in the oxalic acid aqueous solution) should take about ten minutes to separate the positive active material layers 152 from the positive current collector 151. In the technique of the present embodiment, on the other hand, the treatment time can be shortened to 30 to 45 seconds.

Meanwhile, as shown in the reaction formula (1), Li of the materials for treatment PM constitutes a water-soluble compound (lithium phosphate) by reaction with phosphoric acid in the previous acid solution treatment step (step S4). On the other hand, Al, Cr, Fe, and others as well as transition metals (Ni, Co) constitute poorly water-soluble compounds (nickel phosphate, etc.) by reaction with phosphoric acid in the acid solution treatment step (step S4). In particular, Ni, Co, and Mn constitute a very poorly water-soluble compound (nickel phosphate, etc.) by reaction with phosphoric acid. Therefore, Li component (lithium phosphate) of the materials for treatment PM released in the water W is dissolved in the water, while components such as Al, Cr, and Fe as well as transition metal (Ni, Co) are hardly dissolved in the water.

In step S6, the water W containing the materials for treatment PM released therein is taken out of the treatment bath 11 through an outlet port 26 formed in the bottom of the treatment bath 11 and is separated (specifically, filtered) into solid and liquid. Thus, the water W can be divided into a solution (filtrate) containing a lithium component (lithium phosphate) dissolved therein and insoluble components (residue) not dissolved in the water W, the insoluble components including transition metal elements (Ni, Co). Then in step S7, the insoluble components (residue) are recovered. Accordingly, the water soluble components (lithium phosphate and others) can be removed from the materials for treatment PM.

In the present embodiment, steps S6 and S7 correspond to a recovery step.

Herein, the recovered insoluble components (the materials for treatment PM) are subjected to component analysis using an ICP emission spectrophotometer (CIROS-120P manufactured by Rigaku Industrial Corp.). This result shows that 39 wt % of Ni, 7.0 wt % of Co, 2.1 wt % of Al, 4.8 wt % of P, 0.6 wt % of Fe, and 0.1 wt % of Cr are contained. It is found from a measurement using a carbon-sulfur analyzer (CS-444 manufactured by LECO) that 10.0 wt % of C is contained. Other components are oxygen and hydrogen.

Furthermore, the insoluble components are investigated by use of an X-ray diffraction analyzer (XPert PRO manufactured by Spectris Co., Ltd.). The presence of nickel phosphate and cobalt phosphate is confirmed. It can be said that phosphoric acid components constituting the nickel phosphate and the cobalt phosphate are phosphoric acid components originating from the phosphoric acid aqueous solution used in step S4.

In step S8, the recovered insoluble components (the materials for treatment PM) are brought in contact with an oxalic acid aqueous solution. To be concrete, the recovered insoluble components (the materials for treatment PM) and the oxalic acid aqueous solution are put in a reaction vessel and agitated to react with each other. At that time, the transition metal components (Ni, Co) originating from the positive active material constitute poorly water-soluble oxalic acid compounds (see Table 2) and hence they are hardly dissolved in the oxalic acid aqueous solution. It is specifically conceivable that the reaction expressed by the following reaction formulas (3) and (4) occurs.

Ni₃(PO₄)₂+3H₂C₂O₄→3NiC₂O₄+2H₃PO₄ (3)

CO₃(PO₄)₂+3H₂C₂O₄→3CoC₂O₄+2H₃PO₄ (4)

As above, the phosphorous contained in the phosphate generated in previous step S4 is eluted as H₃PO₄ in an aqueous solution. Valuable metals, i.e., Ni and Co, can be separated from the phosphoric components which are impurities.

Other impurities (Al, Fe, Cr, etc.) constitute water soluble compounds, which elute in the oxalic acid aqueous solution. Specifically, they form oxalic acid compounds shown in Table 2 and elute in an aqueous solution. Table 2 also shows solubility of the oxalic acid compounds of main metal elements to 100 g of water.

In the present embodiment, step S8 corresponds to an oxalic acid treatment step.

TABLE 2

| Element | Oxalic acid compound | Solubility to 100 g of water | |
|---|---|---|---|
| Al | Al₂(C₂O₄)₃•XH₂O | Highly soluble | |
| Fe | FeC₂O₄•2H₂O | 22 | mg |
| Cr | Cr₂(C₂O₄)₃•6H₂O | Soluble | |
| K | K₂C₂O₄ | 3700 | mg |
| Ni | NiC₂O₄ | 0.3 | mg |
| Co | CoC₂O₄ | 3.4 | mg |

In step S9, the solution and the insoluble components in the reaction vessel after the oxalic acid treatment are separated (specifically, filtered) into solid and liquid. This can achieve separation into the solution (filtrate) containing the impurities such as Al, Fe, Cr, and P dissolved therein and the transition metal components (residue), Ni and Co. In step SA, the insoluble components (residue) are recovered. Thus, the transition metal components (Ni, Co) originating from the positive active material can be recovered appropriately.

In the present embodiment, particularly, the elution of aluminum is restrained in the previous treatment of step S4 and therefore the content of aluminum (impurities) contained in the materials for treatment PM is low. Consequently, the transition metal components (Ni, Co) with high purity can be efficiently recovered.

Herein, the insoluble components (the components before the oxalic acid treatment) recovered in step S7 and the insoluble components (the components after the oxalic acid treatment) recovered in step SA are subjected to component analysis using a fluorescent X-ray analyzer (ZSX Primus II manufactured by Rigaku Industrial Corp.). Results thereof are shown in Table 3. Table 3 shows a weight percent (wt %) of each component element contained in the insoluble components after the oxalic acid treatment with reference to the weight (100 wt %) of each component element contained in the insoluble component before the oxalic acid treatment.

TABLE 3

| | Before Oxalic acid treatment | After Oxalic acid treatment |
|---|---|---|
| Element | (wt %) | (wt %) |
| Ni | 100 | 100 |
| Co | | 100 |
| P | | 7 |
| Al | | 18 |
| Fe | | 29 |
| Cr | | 12 |

As shown in Table 3, the weights of Ni and Co which are recovery target substances were unchanged before and after the oxalic acid treatment. In other words, 100 wt % of each of Ni and Co could be recovered. On the other hand, 93 to 71 wt % of each of P, Al, Fe, and Cr, which are impurities, could be removed. The above results can reveal that the treatment method of the present embodiment can recover transition metal components (Ni and Co) with high purity.

Herein, the oxalic acid aqueous solution used in step S8 (the oxalic acid treatment step) is examined to find a proper oxalic acid concentration range. To be more precise, six oxalic acid aqueous solutions having different concentrations of oxalic acid; 2.5 wt %, 5 wt %, 10 wt %, 15 wt %, 20 wt %, and 25 wt % are prepared. As in step S8, those oxalic acid aqueous solutions are brought in contact with the insoluble components (the materials for treatment PM containing 4.8 wt % of P) recovered in step S7 to react them. It is to be noted that, since 25 wt % of the oxalic acid aqueous solution will be saturated at 55° C., the temperature of each oxalic acid aqueous solution is set at 55° C.

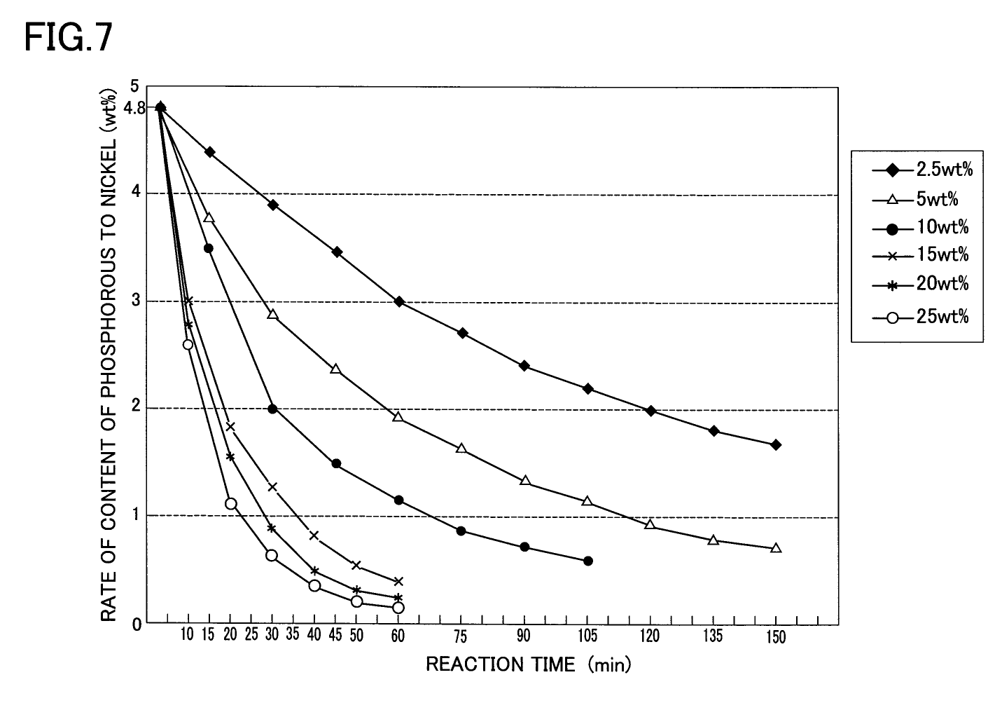

At that time, each oxalic acid aqueous solution is examined to find a relationship between a reaction time and a remaining amount of phosphorous which is an impurity. To be concrete, in the treatment case using 2.5 wt %, 5 wt %, and 10 wt % of the oxalic acid aqueous solutions, samples are extracted from the reaction vessel at intervals of 15 minutes from the reaction start and subjected to the component analysis using the fluorescent X-ray analyzer (ZSX Primus II manufactured by Rigaku Industrial Corp.) to determine the remaining amount of phosphorous. In the treatment case using 15 wt %, 20 wt %, and 25 wt % of oxalic acid aqueous solutions, samples are extracted from the reaction vessels at intervals of 10 minutes from the reaction start and subjected to the component analysis using the fluorescent X-ray analyzer (ZSX Primus II manufactured by Rigaku Industrial Corp.) to determine the remaining amount of phosphorous. Results thereof are shown in FIG. 7.

FIG. 7 shows the remaining amount of phosphorous by the rate of content (wt %) to nickel. A mark ♦ indicates a result of 2.5 wt % of oxalic acid aqueous solution, a mark Δ indicates a result of 5 wt % of oxalic acid aqueous solution, a mark indicates a result of 10 wt % of oxalic acid aqueous solution, a mark x indicates a result of 15 wt % of oxalic acid aqueous solution, a mark * indicates a result of 20 wt % of oxalic acid aqueous solution, and a mark ◯ indicates a result of 25 wt % of oxalic acid aqueous solution.

As shown in FIG. 7, for removal of the same amount of phosphorous, the treatment time (reaction time) is longer as the oxalic acid concentration of the oxalic acid aqueous solution is lower. As the oxalic acid concentration is lower, an increasing rate of the treatment time (reaction time) tends to be larger. The treatment time (reaction time) is desired to be shorter and concretely it is preferably set at 90 minutes or less.

The results shown in FIG. 7 are studied as below. When the concentration of the oxalic acid aqueous solution is 10 wt %, the remaining amount of phosphorous could be reduced to 1 wt % or less in a treatment time (reaction time) of 90 minutes, so that phosphorous which is an impurity could be sufficiently removed. Even when the concentration of oxalic acid is 5 wt %, the remaining amount of phosphorous could be reduced to about 1.3 wt % in a treatment time (reaction time) of 90 minutes.

When the oxalic acid concentration is as low as 2.5 wt %, a treatment capacity largely lowers but the remaining amount of phosphorous could be reduced to about 2.4 wt % for a treatment time (reaction time) of 90 minutes. Regarding the sample containing 4.8 wt % of phosphorous, the content of phosphorous could be reduced to half, 2.4 wt %. It is not preferable to lower the treatment capacity any more. Therefore, the oxalic acid concentration of the oxalic acid aqueous solution is preferably 2.5 wt % or more.

For removal of the same amount of phosphorous, it is found from FIG. 7 that the treatment time (reaction time) can be shorter as the oxalic acid concentration of the oxalic acid aqueous solution is higher. Because as the oxalic acid concentration of the oxalic acid aqueous solution is higher, phosphorous can be dissolved more rapidly. However, if the oxalic acid concentration exceeds 15 wt %, the treatment time less varies. There is no large difference in treatment time between 20 wt % and 25 wt %.

From such tendency, even the use of the oxalic acid aqueous solution having an oxalic acid concentration of 25 wt % or more could hardly shorten the treatment time. Accordingly, the use of the oxalic acid aqueous solution having an oxalic acid concentration of 25 wt % or more is likely to result in waste of oxalic acid. In order to obtain the oxalic acid aqueous solution exceeding 25 wt %, it is also necessary to increase the solution temperature to more than 55° C. (25 wt % of the oxalic acid aqueous solution is saturated at 55° C.). Thus, in the oxalic acid treatment step, more energy is required to heat the oxalic acid aqueous solution. The oxalic acid concentration of the oxalic acid aqueous solution is preferably 25 wt % or less. This makes it possible to avoid wasteful use of the oxalic acid and also save energy to heat the oxalic acid aqueous solution.

In this embodiment, the sample containing 4.8 wt % of phosphorous is a treatment target. If the oxalic acid aqueous solution can reduce the remaining amount of phosphorous in this sample to 1 wt % or less in the treatment time (reaction time) of 90 minutes or less, the oxalic acid aqueous solution is a preferable treatment agent. From the study of the treatment time needed for reducing the remaining amount of phosphorous to 1 wt %, accordingly, FIG. 7 shows about 67 minutes for 10 wt % concentration of the oxalic acid aqueous solution and about 112 minutes for 5 wt % concentration of the oxalic acid. From this tendency, it can be said that the oxalic acid concentration of 7 wt % or higher reduces the remaining amount of phosphorous to 1 wt % or less in the treatment time (reaction time) of 90 minutes or less.

The oxalic acid concentration of the oxalic acid aqueous solution is preferably set to 7 wt % or more. The use of the oxalic acid aqueous solution of 7 wt % or more can treat (dissolve) the impurities such as phosphorous rapidly and sufficiently. Consequently, it is possible to shorten the process time of the oxalic acid treatment and also recover the transition metals (Ni, Co) with high purity.

To increase the oxalic acid concentration of the oxalic acid aqueous solution, however, the temperature of the solution has to be increased. Because the higher the oxalic acid concentration is, the higher the temperature at which the oxalic acid aqueous solution is saturated. In the oxalic acid treatment, on the other hand, the temperature of the oxalic acid aqueous solution is preferably set at a nearly room temperature. This is because heating the oxalic acid aqueous solution is unnecessary, thus saving treatment costs. The oxalic acid aqueous solution of 7 wt % is saturated at 15° C. and the oxalic acid aqueous solution of 15 wt % is saturated at 35° C. Accordingly, the concentration of the oxalic acid aqueous solution is preferably 15 wt % or less.

In the oxalic acid treatment step, as above, it is more preferable to use the oxalic acid aqueous solution having an oxalic acid concentration of 7 wt % or more and 15 wt % or less and set the temperature of the oxalic acid aqueous solution at 15° C. or more and 35° C. or less. These conditions can achieve rapid and sufficient treatment (dissolution) of the impurities such as phosphorous. Furthermore, the oxalic acid aqueous solution hardly needs to be heated. It is economical.

After recovery of the insoluble components (residue) in step SA, the recovered insoluble components (residue) are roasted in an oxygen atmosphere in step SB as shown in FIG. 5. The conductive carbon 161 and the binder resin 162 (carbon component) contained as impurities are burnt out. Specifically, the conductive carbon 161 and the binder resin (carbon component) are oxidized and released as carbon oxide. At that time, the oxalic acid compounds (nickel oxalate, cobalt oxalate) of the transition metals also turn into oxides. Accordingly, transition metal oxides (nickel oxide, cobalt oxide) with high purity can be obtained.

In step SC, the obtained transition metal oxides (NiO, CoO) are immersed in an aqueous sulfuric acid solution. Accordingly, nickel oxide and cobalt oxide are dissolved, forming a solution containing nickel sulfate and cobalt sulfate. Thereafter, in step SD, the solution containing nickel sulfate and cobalt sulfate is agitated in the presence of ammonia ion and is neutralized by a caustic soda (NaOH) aqueous solution. By this neutralizing reaction, transition metal hydroxide (nickel hydroxide and cobalt hydroxide) is deposited in crystals.

After crystal deposition of the transition metal hydroxide (nickel hydroxide and cobalt hydroxide) sufficiently advances and the crystals become spherical, the solution with the crystals in the reaction vessel are separated (filtered) into solid and liquid in step SE. Successively, in step SF, crystal components (residue) are recovered. The transition metal hydroxide (mixture of nickel hydroxide and cobalt hydroxide) crystals are obtained. The obtained transition metal hydroxide (mixture of nickel hydroxide and cobalt hydroxide) crystals are of very high purity, which are highly reusable.

For instance, a precursor is prepared by mixing the crystals of the nickel hydroxide and cobalt hydroxide mixture, the lithium hydroxide, and an additive agent according to a known technique. This precursor is heated in a high-temperature electrical furnace, producing LiNiCoO₂. This produced LiNiCoO₂ can be reused as a positive active material of a lithium battery.

The present invention is explained in the above embodiments but not limited thereto. The present invention may be embodied in other specific forms without departing from the essential characteristics thereof.

For instance, the above embodiment exemplifies the method of treating the lithium battery 100 including the positive active material 153 containing Ni and Co as transition metal elements. However, a lithium battery including a positive active material containing Mn as the transition metal elements may also be subjected to the treatments in steps S1 to SF to recover highly pure Mn (manganese hydroxide).

In the above embodiments, the phosphoric acid aqueous solution PW is used as an acid solution in step S4 (the acid solution treatment step). As an alternative, carbonic acid water or hydrogen sulfide water may be used instead of the phosphoric acid aqueous solution. This also can prevent elution of the aluminum constituting a positive current collector and appropriately separate a positive active material layer from the positive current collector. However, the use of the phosphoric acid aqueous solution is more preferable because it can most prevent the elution of aluminum.

### REFERENCE SIGNS LIST

100 Lithium battery
110 Battery case
150 Electrode assembly
151 Positive current collector
152 Positive active material layer
153 Positive active material
155 Positive electrode member
156 Negative electrode member
PW Phosphoric acid aqueous solution (Acid solution)
PM Material for treatment

1. A method for treating lithium battery comprising a positive electrode member including:
a positive current collector made of aluminum; and
a positive active material layer containing a positive active material made of composite oxide including lithium and a transition metal element, the positive active material layer being fixed to the positive current collector,
the method comprising:
an acid solution treatment step of bringing one acid solution of phosphoric acid solution, carbonic acid water, and hydrogen sulfide water in contact with the positive active material layer and a surface of the positive current collector constituting the positive electrode member to separate the positive active material layer from the positive current collector; and
an oxalic acid treatment step of bringing an oxalic acid aqueous solution in contact with a material for treatment containing a metal component originating from the positive active material layer.

2. The method for treating lithium battery according to claim 1, wherein the transition metal element includes at least one of Ni, Co, and Mn.

3. The method for treating lithium battery according to claim 1, wherein the acid solution treatment step includes spraying the acid solution onto a surface of the positive active material layer.

4. The method for treating lithium battery according to claim 1, further comprising an underwater vibration step of immersing the positive electrode member in which the positive active material layer is separated from the positive current collector in vibrated water to remove the positive active material layer from the positive current collector and release the material for treatment including the metal component originating from the positive active material layer in the water, the underwater vibration step being to be performed after the acid solution treatment step and before the oxalic acid treatment step.

5. The method for treating lithium battery according to claim 4, further comprising a recovery step of separating the water containing the material for treatment released therein into an aqueous solution containing the dissolved lithium component and an insoluble component including the transition metal element and not being dissolved in the water to recover the insoluble component, the recovery step being to be performed after the underwater vibration step and before the oxalic acid treatment step, and
the oxalic acid treatment step including bringing the oxalic acid aqueous solution in contact with the insoluble component.

6. The method for treating lithium battery according to claim 1, wherein the oxalic acid aqueous solution has an oxalic acid concentration of 2.5 wt % or more and 25 wt % or less.

7. The method for treating lithium battery according to claim 6, wherein the oxalic acid concentration of the oxalic acid aqueous solution is 7 wt % or more and 15 wt % or less.

8. The method for treating lithium battery according to claim 7, wherein a temperature of the oxalic acid aqueous solution is 15° C. or more and 35° C. or less.

9. The method for treating lithium battery according to claim 1, wherein the acid solution has an acid concentration of 10 wt % or more and 40 wt % or less.

10. The method for treating lithium battery according to claim 9, wherein the acid concentration of the acid solution is 15 wt % or more and 25 wt % or less.
